(19) United States
(12) Patent Application Publication
(10) Pub. No.: US 2026/0021429 A1
(43) Pub. Date: Jan. 22, 2026

(54) GRID STRUCTURE FOR FILTER DEVICE

(71) Applicant: ANDRITZ SEPARATION INC., South Arlington, TX (US)

(72) Inventors: Paul R. Allen, South Arlington, TX (US); Farooq Ellahi, South Arlington, TX (US); Matthew Stuart, South Arlington, TX (US)

(21) Appl. No.: 18/996,218

(22) PCT Filed: Jul. 12, 2023
(86) PCT No.: PCT/US2023/027510

§ 371 Date: Jan. 17, 2025

Related U.S. Application Data
(60) Provisional application No. 63/399,378, filed on Aug. 19, 2022.
(60) Provisional application No. 63/438,407, filed on Jan. 11, 2023.

(51) Int. Cl. B01D 33/23; B01D 33/19

(52) U.S. Cl. CPC B01D 33/23; B01D 33/19

(57) ABSTRACT

A filtration grid for a cell vessel includes: a plurality of supports disposed in a parallel configuration from a first end wall to a second end wall of the cell vessel, each support of the plurality of supports extending from a first sidewall to a second sidewall of the cell vessel. The supports are configured to provide a first specified amount of filtration grid area as open area and a second specified amount of the filtration grid area as support area for a filter element of the cell vessel.

### BACKGROUND

Unless otherwise indicated herein, the materials described in this section are not prior art to the claims in this application and are not admitted to being prior art by inclusion in this section.

Tilting pan filters are used in the phosphoric acid industry. The operation of tilting pan filters is based on a series of horizontal independent trapezoidal pans, or cell vessels, mounted on a circular supporting structure that rotates under vacuum during the filtration cycle. Each cell vessel consists of a filtration grid and a filter cloth supported on a surface of the filtration grid. A phosphate slurry is dispensed on the filter cloth in the cell vessels and inverted to discharge the cake. Filtrate is drawn through the filter cloth by the vacuum and channeled by the filtration grid to a trough and collected.

A general problem with filter pans is that of scale build-up. Scale build-up can occur during filtering of the slurry as the filtrate cools from contact with the cell vessel as well as when the filter pan is washed by relatively cool wash water. The buildup of scale can block drain holes in the filtration grid thereby preventing the flow of filtrate from the filtration grid to the collection trough.

### SUMMARY

Provided are cell vessel filtration grids formed with individual supports that can improve filtrate drainage and reduce clogging.

According to various aspects there is provided a cell vessel. In some aspects, the cell vessel may include: a frame having a first sidewall and a second sidewall disposed opposite the first sidewall, and a first end wall and a second end wall disposed opposite the first end wall; and a filtration grid extending from the first end wall to the second end wall, the filtration grid including: a plurality of supports disposed in a parallel configuration from the first end wall to the second end wall, each support of the plurality of supports extending from the first sidewall to the second sidewall. The supports are configured to provide a first specified amount of filtration grid area as open area between adjacent supports and a second specified amount of filtration grid area as support area for a filter element of the cell vessel provided by at least a portion of an upper surface of the adjacent supports.

According to various aspects there is provided a filtration grid for a cell vessel. In some aspects, the filtration grid may include: a plurality of supports disposed in a parallel configuration from a first end wall to a second end wall of the cell vessel, each support of the plurality of supports extending from a first sidewall to a second sidewall of the cell vessel. The supports are configured to provide a first specified amount of filtration grid area as open area between adjacent supports and a second specified amount of filtration grid area as support area for a filter element of the cell vessel provided by at least a portion of an upper surface of the adjacent supports.

### BRIEF DESCRIPTION OF THE DRAWINGS

Aspects and features of the various embodiments will be more apparent by describing examples with reference to the accompanying drawings, in which:

FIG. 1A is a perspective view illustrating an example of a tilting pan filter;

FIG. 1B is a perspective view illustrating an example of a cell vessel according to some aspects of the present disclosure;

FIGS. 2A-2C are perspective views illustrating an example of a filtration grid installed in the cell vessel according to some aspects of the present disclosure;

FIG. 3 is an expanded perspective view illustrating an example of a portion of a filtration grid installed in the cell vessel according to some aspects of the present disclosure;

FIG. 4A is diagram illustrating an example of a profile of a filtration grid having rectangular supports according to some aspects of the present disclosure;

FIG. 4B is a diagram illustrating an example of a profile of a filtration grid having square supports according to some aspects of the present disclosure;

FIG. 4C is diagram illustrating an example of a profile of a filtration grid having round supports according to some aspects of the present disclosure;

FIG. 5 is a perspective view illustrating a portion of a filtration grid including a cell vessel grid bridge assembly installed in the cell vessel according to some aspects of the present disclosure;

FIG. 6A is a perspective view illustrating an example of a cell vessel grid bridge assembly according to some aspects of the present disclosure;

FIG. 6B is a diagram illustrating an example of the cell vessel grid bridge assembly coupled to portions of a filtration grid according to some aspects of the present disclosure;

FIG. 7A is a perspective view illustrating an example of a portion of a filtration grid according to some aspects of the present disclosure;

FIG. 7B is a diagram illustrating an example of a cross-section of a filtration grid according to some aspects of the present disclosure;

FIG. 8 is a perspective view illustrating an example of cell vessel bridge according to some aspects of the present disclosure;

FIG. 9A is a diagram illustrating an example of a top view of a cell vessel grid bridge according to some aspects of the present disclosure;

FIG. 9B is a diagram illustrating an example of a side view of a cell vessel grid bridge according to some aspects of the present disclosure;

FIG. 9C is a diagram illustrating an example of end view of a cell vessel grid bridge according to some aspects of the present disclosure;

FIG. 10 is a perspective view illustrating an example of a portion of a cell vessel grid bridge assembly installed in a cell vessel according to some aspects of the present disclosure; and

FIG. 11 is a diagram illustrating an example of bottom view of a cell vessel grid bridge assembly coupled to portions of a filtration grid according to some aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Each cell vessel of a tilting pan filter includes a filtration grid and a filter element, for example, a filter cloth, supported on a surface of a filtration grid. A phosphate slurry is dispensed on the filter cloth in the cell vessel and filtrate is drawn through the filter cloth by the vacuum and channeled by the filtration grid to a trough and collected.

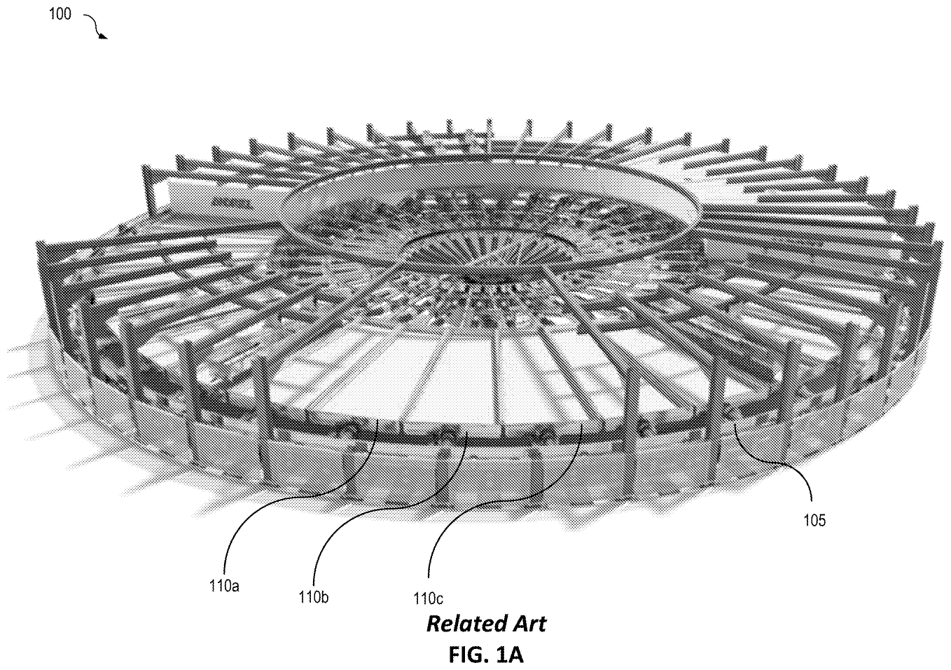

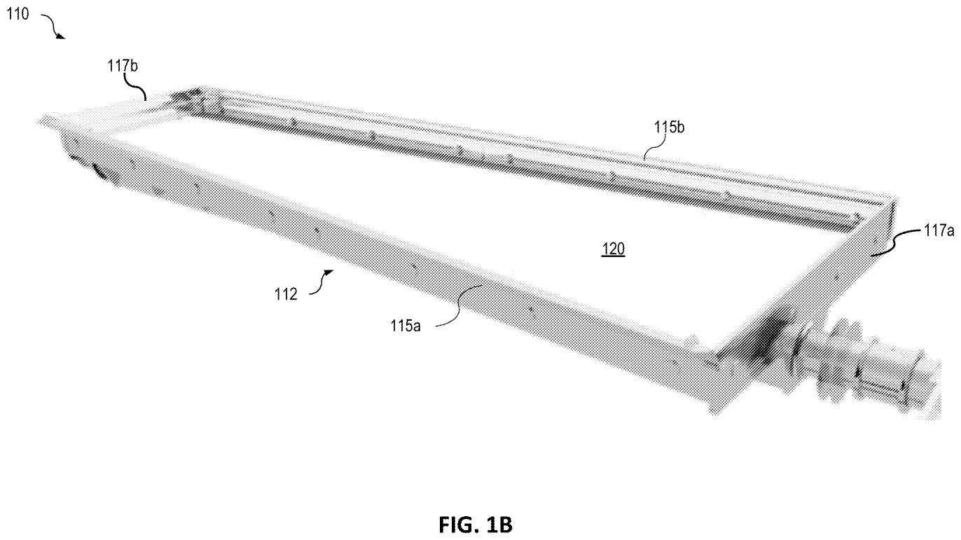

FIG. 1A is a diagram illustrating an example of a tilting pan filter 100. As illustrated in FIG. 1A, the tilting pan filter 100 may include multiple cell vessels 110a-110c. The multiple cell vessels 110a-110c rotate on a circular supporting structure 105 while receiving and filtering the phosphate slurry.

FIG. 1B is a diagram illustrating an example of a cell vessel 110 according to some aspects of the present disclosure. The cell vessel 110 may include a frame 112 having first and second sidewalls 115a, 115b, respectively, extending from a first end wall 117a of the cell vessel to a second end wall 117b of the cell vessel 110. The frame may be configured to support a filtration grid (not shown). The filtration grid provides support for the filter element 120 (e.g., the filter cloth). In operation, filtrate is pulled through the filter cloth 120 under vacuum onto the filtration grid and flows into a fluid collection trough (not shown). While the filter cloth 120 is described as a cloth, it should be appreciated that other filter mediums may be used without departing from the scope of the present disclosure.

According to aspects of the present disclosure, a cell vessel having a filtration grid formed with individual supports can improve filtrate drainage and reduce clogging of the filtration grid by increasing the open area for drainage into the fluid collection trough while maintaining adequate support for the filter cloth.

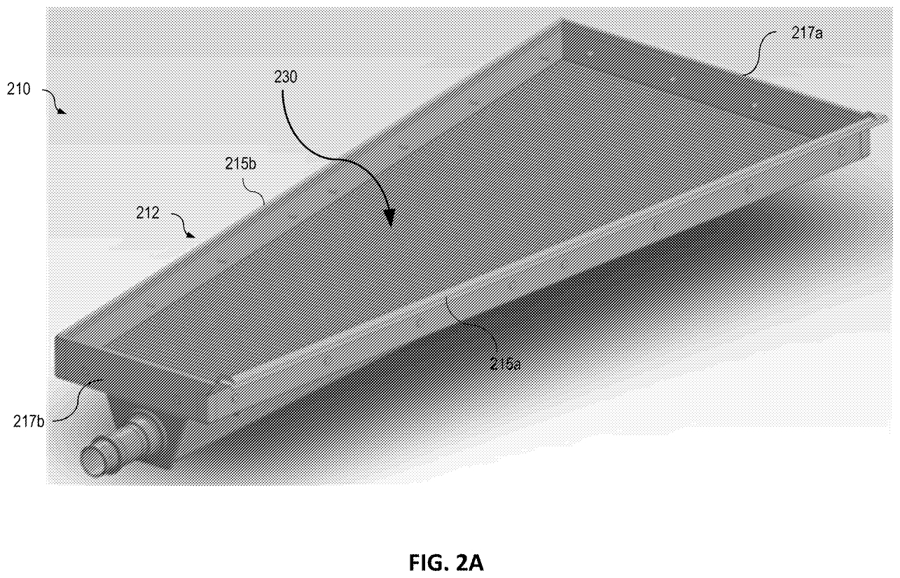

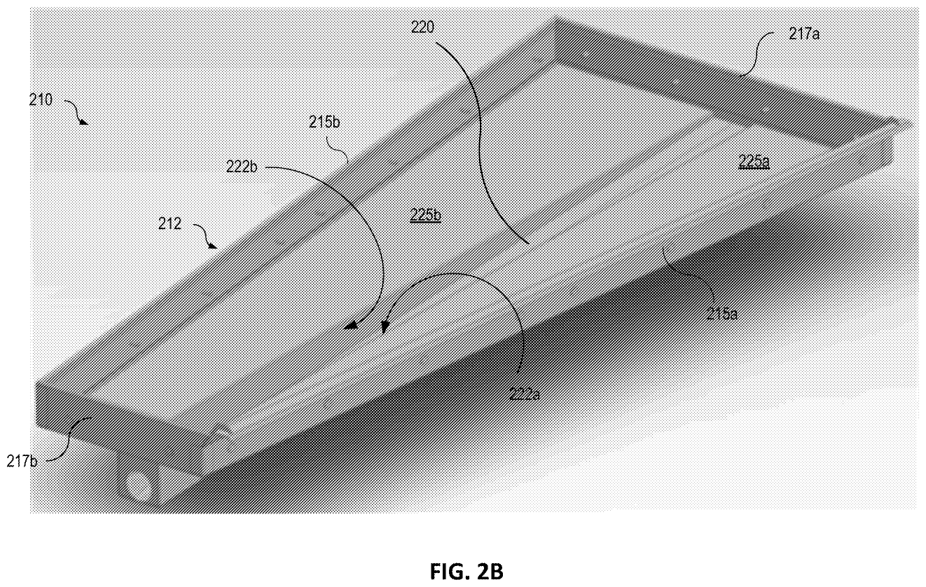

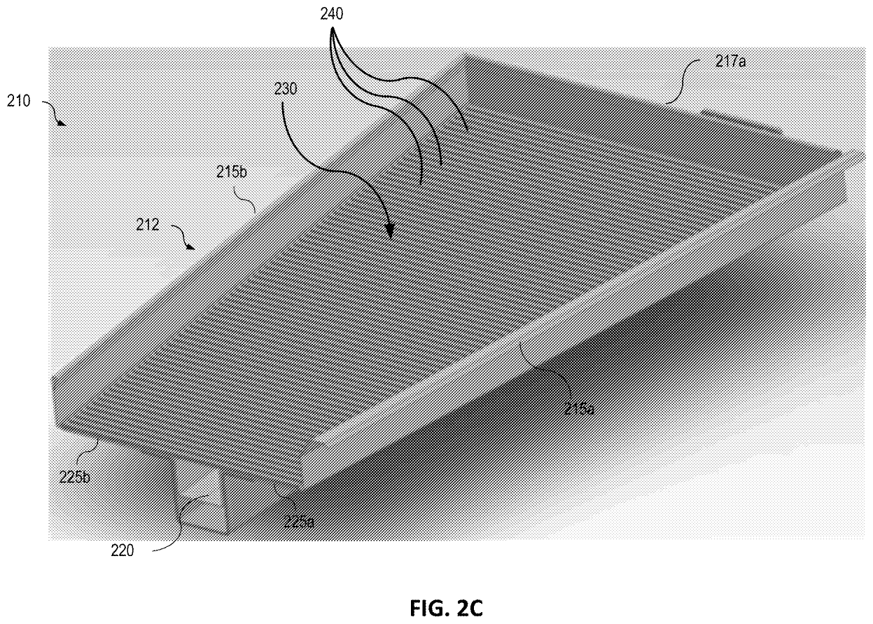

FIGS. 2A-2C are perspective views illustrating an example of a filtration grid 230 installed in the cell vessel 210 according to some aspects of the present disclosure. Referring to FIG. 2A, the cell vessel 210 may include a frame 212 having a first sidewall 215a and a second sidewalls 215b disposed opposite of the first sidewall 215a. The first and second sidewalls 215a, 215b may extend from a first end wall 217a of the cell vessel to a second end wall 217b of the cell vessel 210 disposed opposite to the first end wall 217a. The frame 212 may be configured to support a filtration grid 230. A filter element such as the filter cloth 120 illustrated in FIG. 1B may be attached to the frame 212 and disposed over the filtration grid 230.

Referring to FIG. 2B, the cell vessel 210 may further include a fluid collection trough 220 and first and second support plates 225a, 225b. The fluid collection trough 220 may have a length extending from the first end wall 217a of the cell vessel 210 to the second end wall 217b of the cell vessel 210 and may be disposed midway between first and second sidewalls 215a, 215b, respectively. The first and second support plates 225a, 225b may be flat sheets of metal or another suitable material extending from the first end wall 217a of the cell vessel 210 to the second end wall 217b of the cell vessel 210. The first support plate 225a may extend from the first sidewall 215a to a first side 222a of the fluid collection trough 220. The second support plate 225b may extend from the second sidewall 215b to a second side 222b of the fluid collection trough 220. The first and second support plates 225a, 225b may be configured to support the filtration grid 230 on either side of the fluid collection trough 220.

FIG. 2C is a cutaway view of the cell vessel 210 illustrating the filtration grid 230 installed on the first and second support plates 225a, 225b over the fluid collection trough 220. The filtration grid 230 may include a series of supports 240 disposed along the length of the frame 212 from the first end wall 217a of the cell vessel 210 to the second end wall 217b of the cell vessel 210. Each of the supports 240 may extend across the cell vessel 210 from the first sidewall 215a to the second sidewall 215b. The supports 240 may be coupled to the first and second support plates 225a, 225b and to the first and second sidewalls 215a, 215b by intermittent welding, spot welding, tack welding, or by another coupling method. The supports may have profiles such as rectangular, square, round, or other extruded shapes. The profiles maybe hollow tubes or of solid structures.

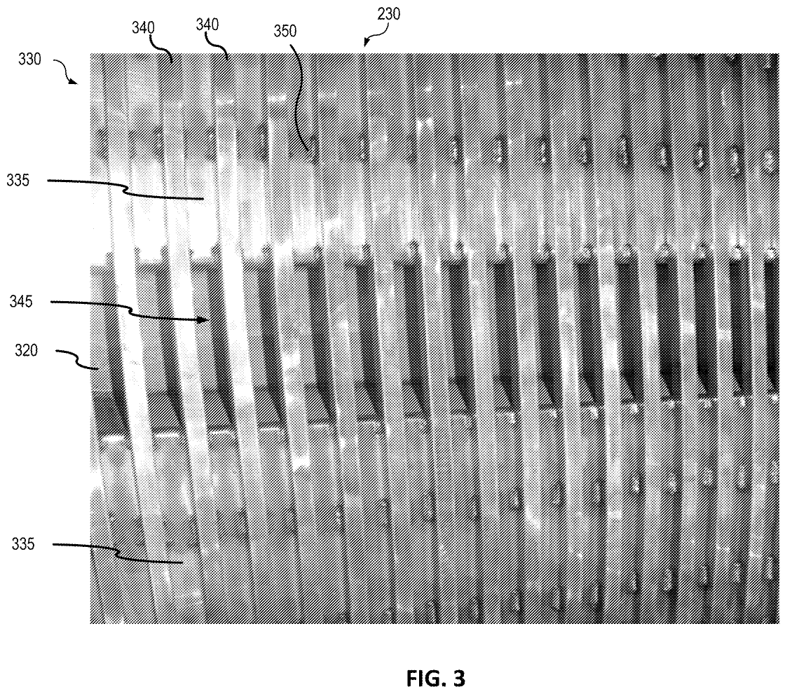

FIG. 3 is an expanded perspective view illustrating an example of a portion of a filtration grid 330 installed in the cell vessel according to some aspects of the present disclosure. The filtration grid 330 may be the filtration grid 230 illustrated in FIGS. 2A and 2C. The filtration grid 330 may be configured to support a filter element (e.g., the filter cloth 120) and may provide drainage channels 335 between adjacent supports 340 to direct filtrate drawn through the filter cloth to the fluid collection trough 320. In the implementation illustrated in FIG. 3, the supports 340 are coupled to the support plates with intermittent welds 350.

Drainage slots 345 formed between adjacent supports 340 of the filtration grid 330 may be provided over the fluid collection trough 320 to permit the filtrate to be drawn from the drainage channels 335 into the fluid collection trough 320 under vacuum supplied through the fluid collection trough 320. The size of each drainage slot 345 in the filtration grid 330 may correspond to the width of the drainage channel 335 and may extend across the width of the fluid collection trough 320 from the first side 222a of the fluid collection trough 320 to the second side 222b of the fluid collection trough 320. In some implementations, the drainage slots may have a width different than the width of the drainage channel.

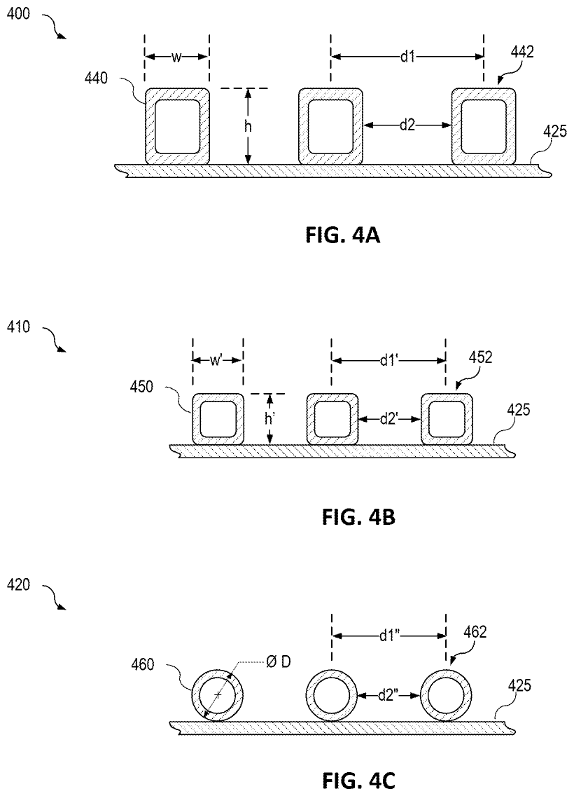

FIG. 4A is a diagram illustrating an example of a profile 400 of a filtration grid having rectangular supports 440 according to some aspects of the present disclosure. The rectangular supports 440 may be coupled to a support plate for 425, for example, by intermittent welding, spot welding, tack welding, or by another method. The rectangular supports 440 may be the supports 340 illustrated in FIG. 3. The support plate 425 may be one of the first and second support plates 225a, 225b, illustrated in FIGS. 2B and 2C.

The rectangular supports 440 may be rectangular solid bars or rectangular hollow tubes. When hollow tubes are used, the rectangular supports 440 may be sealed to the sidewalls (e.g., the first and second sidewalls 215a, 215b), for example, by welding or by another method to prevent process materials from entering the tubes during operation the cell vessel. The rectangular supports 440 may be fabricated from materials compatible with the process for which they will be used. For example, for use with a corrosive process using phosphoric acid, the rectangular supports 440 may be fabricated from corrosion resistant stainless steel (e.g., Alloy 317L (UNS S31703)) or another alloy. It should be appreciated that other corrosion resistant materials, for example, but not limited to plastics, may be used to fabricate the rectangular supports 440 for use with a corrosive process.

The filtration grid may be configured to provide a specified amount of open area between the rectangular supports 440 in relation to a specified amount of support area for the filter element (e.g., the filter cloth 120) provided by at least a portion of the upper surface 442 of the rectangular supports 440. For example, the filtration grid may be configured to provide 60% of the filtration grid area as open area and 40% of the filtration grid area as filter element support area. The open area between the rectangular supports 440 may provide drainage channels for filtrate drawn through the filter element. The support area for the filter element may prevent the filter element from sagging into the drainage channels.

Each of the rectangular supports 440 may have a height ‘h’ greater than a width ‘w’. For example, each rectangular support 440 may have a height of approximately 0.75 inches (20 mm) and a width of approximately 0.625 inches (15 mm). Other height and width dimensions for the rectangular supports 440 may be used without departing from the scope of the present disclosure.

The rectangular supports 440 may be spaced a distance ‘d1’ between centers to provide a spacing of ‘d2’ between each rectangular support 440. The dimensions ‘d1’ and ‘d2’ may be specified to obtain the desired amount of open area with respect to filter cloth support for the filtration grid with rectangular supports 440 of ‘w’ width. The ratio of open area with respect to filter cloth support may be in a range of 50% open area/50% support to 60% open area/40% support. For example, to provide 60% of the filtration grid area as open area and 40% of the filtration grid area as filter cloth support area with rectangular supports 440 having a width ‘w’ of 0.625 inches, the rectangular supports 440 may be coupled to the support plates (e.g. the support plates) with a spacing ‘d1’ of approximately 1.5 inches on center.

Based on dimensions above, d2=d1−w=0.875 inches. The open area is equal to d2/d1=0.58˜60%. The filter cloth support is equal to w/d1=0.42˜40%. Other dimensions may be specified to provide different percentages of open area with respect to filter cloth support without departing from the scope of the present disclosure.

FIG. 4B is a diagram illustrating an example of a profile 410 of a filtration grid having square supports 450 according to some aspects of the present disclosure. The square supports 450 may be coupled to a support plate 425, for example, by intermittent welding, spot welding, tack welding, or by another method. The square supports 450 may be the supports 340 illustrated in FIG. 3. The support plate 425 may be one of the first and second support plates 225a, 225b, illustrated in FIGS. 2B and 2C.

The square supports 450 may be square solid bars or square hollow tubes. When hollow tubes are used, the square supports 450 may be sealed to the sidewalls (e.g., the first and second sidewalls 215a, 215b), for example, by welding or by another method to prevent process materials from entering the tubes during operation the cell vessel. The square supports 450 may be fabricated from materials compatible with the process for which they will be used. For example, for use with a corrosive process, the square supports 450 may be fabricated from corrosion resistant stainless steel (e.g., Alloy 317L (UNS S31703)) or another alloy. It should be appreciated that other corrosion resistant materials, for example, but not limited to plastics, may be used to fabricate the square supports 450 for use with a corrosive process.

The filtration grid may be configured to provide a specified amount of open area between the square supports 450 in relation to a specified amount of support for the filter cloth (e.g., the filter cloth 120) provided at least a portion of the upper surface 452 of by the square supports 450. The open area between the square supports 450 may provide drainage channels (e.g., the drainage channels 335) for filtrate drawn through the filter element. The support area for the filter element may prevent the filter element from sagging into the drainage channels. Each of the square supports 450 may have a height ‘h′’ equal to a width “w”. The square supports 450 may be spaced a distance ‘d1′’ between centers to provide a spacing of ‘d2′’ between each square support 450. The dimensions ‘d1’ and ‘d2′’ may be specified to obtain the desired amount of open area with respect to filter cloth support for the filtration grid with square supports 450 of ‘w′’ width. The ratio of open area with respect to filter cloth support may be in a range of 50% open area/50% support to 60% open area/40% support.

FIG. 4C is a diagram illustrating an example of a profile 420 of a filtration grid having round supports 460 according to some aspects of the present disclosure. The round supports 460 may be coupled to a support plate 425, for example, by intermittent welding, spot welding, tack welding, or by another method. The round supports 460 may be the supports 340 illustrated in FIG. 3. The support plate 425 may be one of the first and second support plates 225a, 225b illustrated in FIGS. 2B and 2C.

The round supports 460 may be round solid bars or round hollow tubes. When hollow tubes are used, the round supports 460 may be sealed to the sidewalls (e.g., the first and second sidewalls 215a, 215b), for example, by welding or by another method to prevent process materials from entering the tubes during operation the cell vessel. The round supports 460 may be fabricated from materials compatible with the process for which they will be used. For example, for use with a corrosive process, the round supports 460 may be fabricated from corrosion resistant stainless steel (e.g., Alloy 317L (UNS S31703)) or another alloy. It should be appreciated that other corrosion resistant materials, for example, but not limited to plastics, may be used to fabricate the round supports 460 for use with a corrosive process.

The filtration grid may be configured to provide a specified amount of open area between the round supports 460 in relation to a specified amount of support for the filter cloth (e.g., the filter cloth 120) provided by at least a portion of the upper surface 462 of the round supports 460. The open area between the round supports 460 may provide drainage channels for filtrate drawn through the filter element. The support area for the filter element may prevent the filter element from sagging into the drainage channels. Each of the round supports 460 may have a diameter ‘D’. The round supports 460 may be spaced a distance ‘d1′’ between centers to provide a spacing of ‘d2″’' between each round support 450. The dimensions ‘d1″’ and ‘d2″’ may be specified to obtain the desired amount of open area with respect to filter cloth support for the filtration grid with round supports 460 of diameter ‘D’. The ratio of open area with respect to filter cloth support may be in a range of 50% open area/50% support to 60% open area/40% support. In some implementations, for example, but not limited to, filtration grids produced with plastic or fiber/resin materials, the filtration grid may have a higher percentage of open area using narrower channels. In such implementations, the open area may be greater than 50% of the filtration grid area and the support may be less than 50% of the filtration grid area.

Examples of a cell vessel having a filtration grid formed with individual supports has been described and illustrated. The filtration grid formed with individual supports can improve filtrate drainage and reduce clogging of the filtration grid by increasing the open area for drainage into the fluid collection trough while maintaining support for the filter cloth. In some implementations, filtration grids may be formed with a combination of support shapes and/or supports having a combination of different dimensions. For example, the filtration grid may include a combination of rectangular and square supports, a combination of square and round supports, or a combination of rectangular and round supports. As another example, the filtration grid may include rectangular supports with one or more of the rectangular supports having different dimensions, for example, height and/or width, than other rectangular supports in the filtration grid. Similarly, the filtration grid may include square supports with one or more of the square supports having different dimensions, for example, height and/or width, than other square supports in the filtration grid or the filtration grid may include round supports with one or more of the round supports having different dimensions, for example, different diameters, than other round supports in the filtration grid.

In some implementations, the filtration grid may include a combination of supports having a solid cross-section and supports having a hollow cross-section. It should be appreciated that any combination of the above supports may be provided in a filtration grid without departing from the scope of the present disclosure. Further, in some implementations the filtration grid may have uniform spacings between the supports. In some implementations, the spacings between the supports of the filtration grid may be nonuniform such that some adjacent supports may be disposed closer together or further apart than other adjacent supports.

According to further aspects of the present disclosure, a cell vessel grid bridge assembly including a center channel portion disposed above the fluid collection trough and having a reduced width portion compared to a width of the trough portions of the substantially corrugated shape of the filtration grids. The reduced width portions of the center channel portion can provide openings or slots through which filtrate may be drawn into the fluid collection trough. The cell vessel grid bridge assembly can improve filtrate drainage and reduce clogging of the filtration grid by increasing the open area for drainage into the fluid collection trough while maintaining adequate support for the filter cloth.

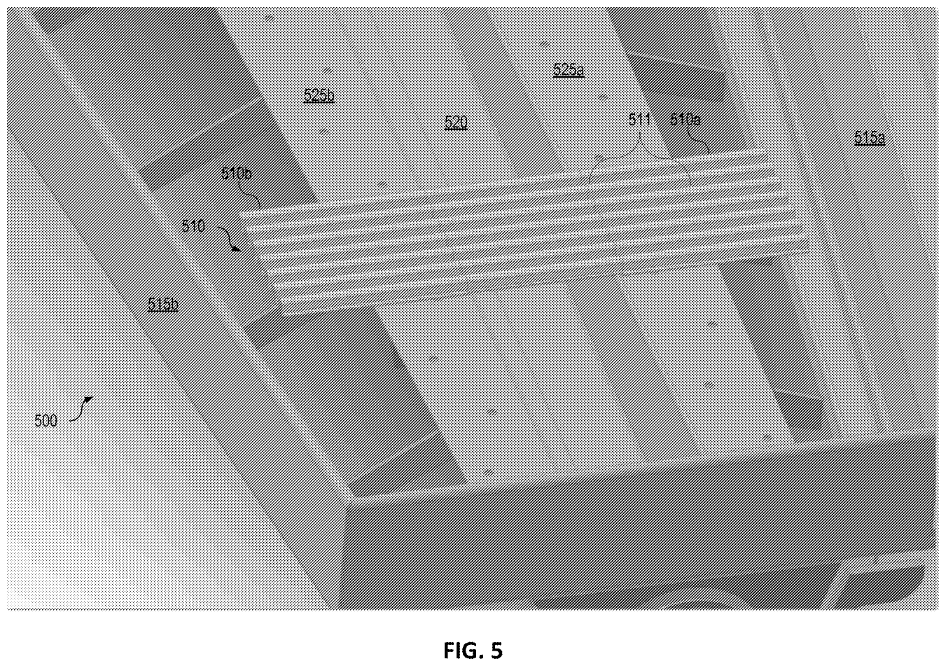

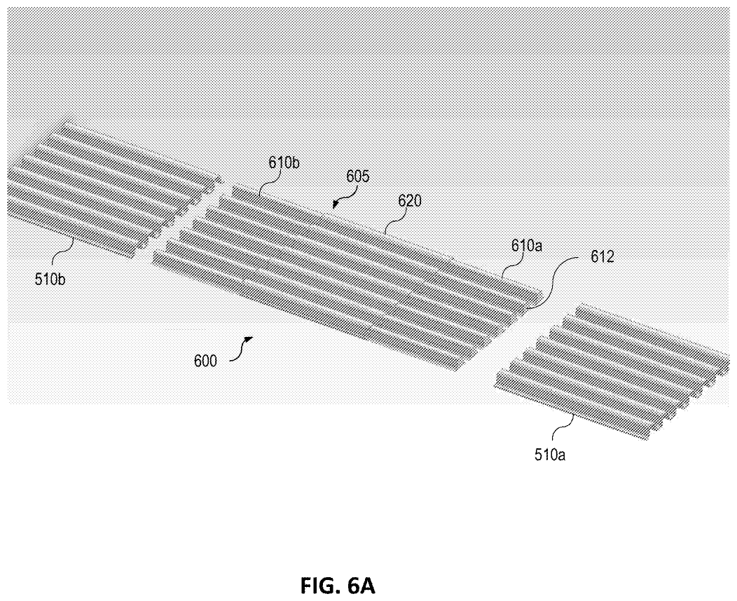

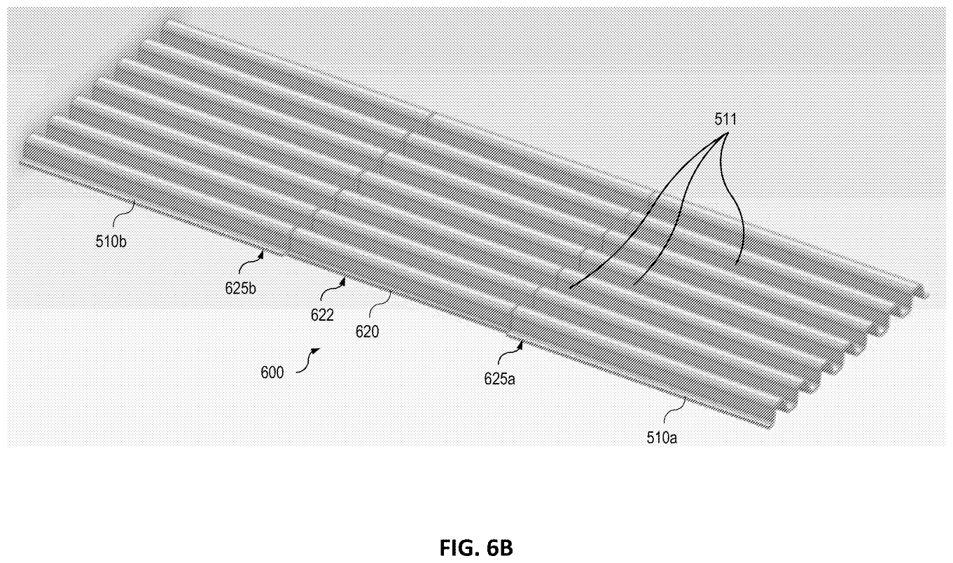

FIG. 5 is a perspective view illustrating a portion of a filtration grid 510 including a cell vessel grid bridge assembly (see FIG. 6A) installed in a cell vessel 500 according to some aspects of the present disclosure. The cell vessel 500 may include a fluid collection trough 520 and support plates 525a, 525b. The support plates 525a, 525b may be configured to support the filtration grid 510 over the fluid collection trough 520.

The filtration grid 510 may have a first grid portion 510a and a second grid portion 510b. The filtration grid 510 may have a generally corrugated shape configured to provide channels 511 for filtrate drawn through the filter cloth to be directed to the fluid collection trough 520. Openings in the filtration grid 510 are provided over the fluid collection trough 520 to permit the filtrate to flow from the channels 511 into the fluid collection trough 520. The filtration grid 510 extends to the sidewalls 515a, 515b of the cell vessel 500 and also extends over the length of the cell vessel 500.

FIG. 6A is a perspective view illustrating an example of a cell vessel grid bridge assembly 600 according to some aspects of the present disclosure. As illustrated in FIG. 6A, the cell vessel grid bridge assembly 600 may include multiple cell vessel grid bridges 605, each having a first end portion the 610a, a second end portion 610b, and a center channel portion 620. The center channel portion 620 may include a reduced width portion compared to a width of the trough portions of the substantially corrugated shape of the filtration grid 510. The center channel portion 620 may span the fluid collection trough (e.g., the fluid collection trough 520 shown in FIG. 5) and reduced width portions of the center channel portions 620 may provide openings or slots through which filtrate may be drawn into the fluid collection trough 520.

The first and second end portions 610a, 610b may be coupled to the first and second grid portions 510a, 510b of the filtration grid 510, and the first and second grid portions 510a, 510b of the filtration grid 510 may extend to the respective sidewalls of the cell vessel (e.g., the sidewalls 515a, 515b of the cell vessel 500 shown in FIG. 5).

The first and second end portions 610a, 610b may have an outer profile that corresponds to an inner profile of the filtration grid 510. The center channel portion 620 may have an outer profile corresponding to the outer profile of the filtration grid 510.

The first and second end portions 610a, 610b may have solid cross-sections 612 and may be sealed to the first and second grid portions 510a, 510b, respectively, for example, by welding or by another sealing process. Alternatively, the ends of the first and second end portions 610a, 610b may be substantially hollow. In such cases, additional material may be added to the first and second end portions 610a, 610b to provide a solid cross-section or to cap the end portions. When sealed to the first and second grid portions 510a, 510b, the solid cross-sections of the first and second end portions 610a, 610b enable vacuum to be maintained under the filter cloth (e.g., the filter cloth 120 is shown in FIG. 1B).

FIG. 6B is a diagram illustrating an example of the cell vessel grid bridge assembly 600 coupled to portions of a filtration grid according to some aspects of the present disclosure. As illustrated in FIG. 6B, the outer profile of the center channel portions 620 of the cell vessel grid bridge assembly 600 substantially match the outer profile of the first and second grid portions 510a, 510b. As also shown in FIG. 6B, the widths of the trough portions 625a, 625b of first and second grid portions 510a, 510b are wider than the reduced width portions 622 of the center channel portion 620 of the cell vessel grid bridge assembly 600, thereby forming slots or openings in the cell vessel grid bridge assembly 600. The slots or openings permit filtrate to be drawn from the channels 511 into the fluid collection trough 520. The reduced width portions 622 may be configured to form slots having a length substantially corresponding to the length of the center channel portion 620. In some implementations, the slots may have a length less than the length of the center channel portion 620.

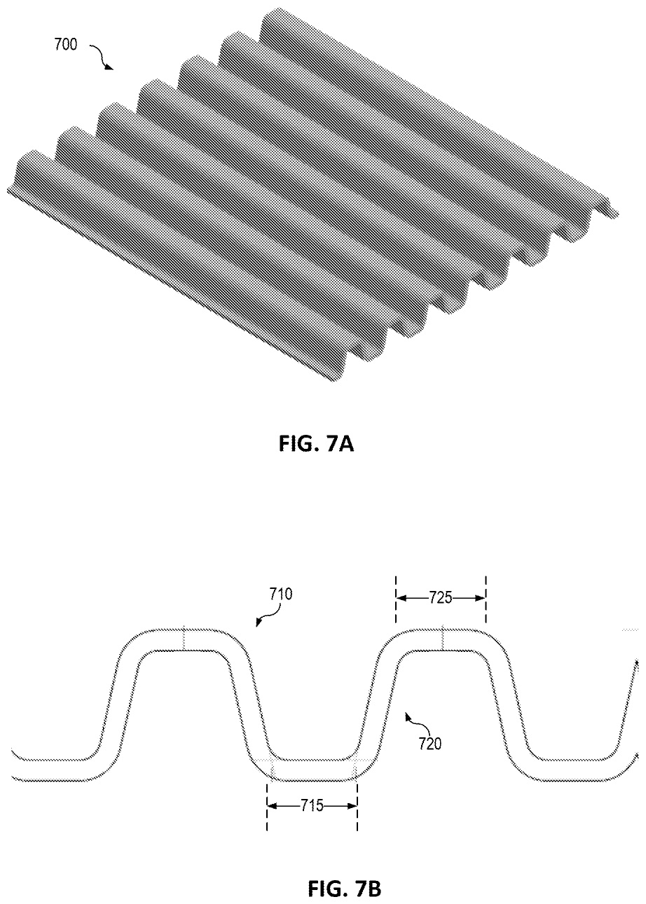

FIG. 7A is a perspective view illustrating an example of a portion of a filtration grid 700 according to some aspects of the present disclosure. The portion of the filtration grid may be, for example, a portion of the filtration grids 510. The generally corrugated shape of the filtration grid 700 may have a particular profile. FIG. 7B is a diagram illustrating an example of a cross-section of the filtration grid 700 according to some aspects of the present disclosure.

As illustrated in FIG. 7B, the cross-section of the filtration grid 700 illustrates the troughs 715 and crests 725 of the substantially corrugated shape having an outer profile 710 and an inner profile 720. The outer profile of the center channel portion 620 of the cell vessel grid bridge assembly 600 substantially matches the outer profile 710 of the filtration grid 700. The outer profile of the first and second end portions 610a, 610b of the cell vessel grid bridge assembly 600 substantially match the inner profile 720 of the filtration grid 700. The matching profiles enable level support for the filter cloth and enable sealing of the filtration grid 700 and cell vessel grid bridge assembly 600 to maintain vacuum under the filter cloth. The profile of the cell vessel grid bridge assembly 600 may be modified to adapt to other filtration grid profiles.

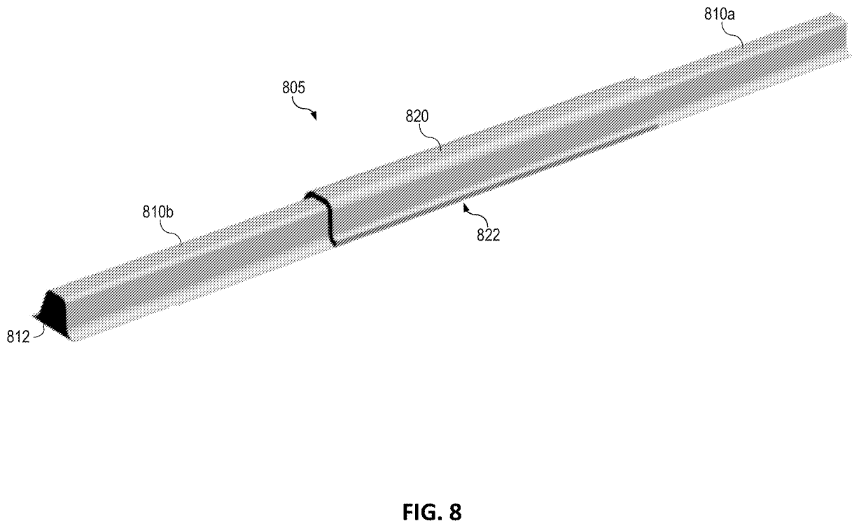

The cell vessel grid bridge assembly 600 may include a plurality of cell vessel grid bridges. FIG. 8 is a perspective view illustrating an example of cell vessel grid bridge 805 according to some aspects of the present disclosure. The cell vessel grid bridge 805 may be the cell vessel grid bridge 605 illustrated in FIG. 6A. The cell vessel grid bridge 805 may include a first end portion 810a, a second end portion 810b, and a center channel portion 820. The first and second end portions 810a, 810b may have an outer profile that corresponds to an inner profile of the filtration grid (e.g., the filtration grid 510 or the filtration grid 700). The center channel portion 820 may have an outer profile corresponding to the outer profile of the filtration grid. The profile of the cell vessel grid bridge 805 may be modified to adapt to filtration grid profiles other than as shown. The first and second end portions 810a, 810b of the cell vessel grid bridge 805 may have a solid cross-section 812.

The reduced width portions 822 of the center channel portion 820 of the cell vessel grid bridge 805 may have widths narrower than the widths of the trough portions (e.g., the trough portions 625a, 625b) of the filtration grid (e.g., the filtration grid 510). The reduced width portions 822 may be configured to form slots having a length substantially corresponding to the length of the center channel portion 820. When assembled as a cell vessel grid bridge assembly (e.g., the cell vessel grid bridge assembly 600), the narrower widths of the cell vessel grid bridges 805 form slots or openings in the cell vessel grid bridge assembly 600. In some implementations, the slots may have a length less than the length of the center channel portion 820.

In some embodiments, the center channel portion 820 and the first and second end portions 810a, 810b may be fabricated by investment casting or another fabrication method as a single piece. In some embodiments, the first and second end portions 810a, 810b may be fabricated as a single piece and the center channel portion 820 fabricated as a separate piece. The center channel portion 820 may be sealed to the first and second end portions 810a, 810b, for example, by welding or by another sealing process. In some embodiments, the first and second end portions 810a, 810b and the center channel portion 820 fabricated as separate pieces. The center channel portion 820 may be sealed to the first and second end portions 810a, 810b, for example, by welding or by another sealing process.

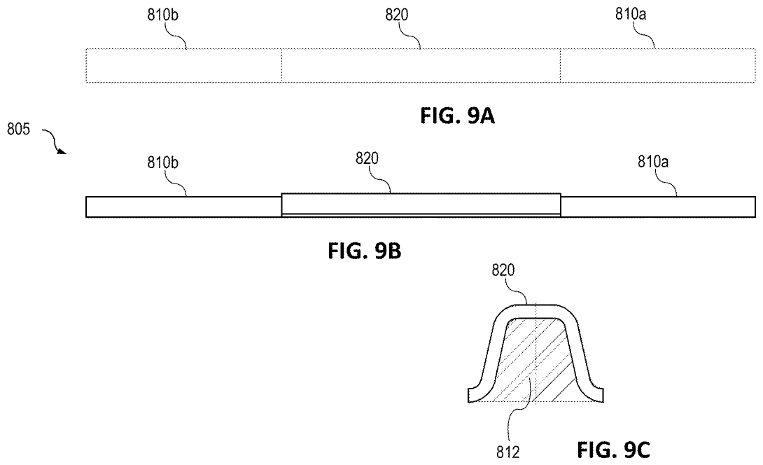

FIG. 9A is a diagram illustrating an example of a top view of a cell vessel grid bridge 805 and filtration grids according to some aspects of the present disclosure. As illustrated in FIG. 9A, the outer profile of the center channel portion 820 of the cell vessel grid bridge 805 substantially matches the outer profile of the filtration grid (e.g., the filtration grid 510) thereby providing a level surface for the filter cloth.

FIG. 9B is a diagram illustrating an example of a side view of a cell vessel grid bridge 805 according to some aspects of the present disclosure. FIG. 9B illustrates the first and second end portions 810a, 810b of the cell vessel grid bridge 805 having a different profile than the center channel portion 820. The first and second end portions 810a, 810b may have an outer profile that corresponds to an inner profile of the filtration grid (e.g., the filtration grid 510).

FIG. 9C is a diagram illustrating an example of an end view of a cell vessel grid bridge 805 according to some aspects of the present disclosure. As shown in FIG. 9C, the first and second end portions 810a, 810b of the cell vessel grid bridge 805 may have a solid cross-section.

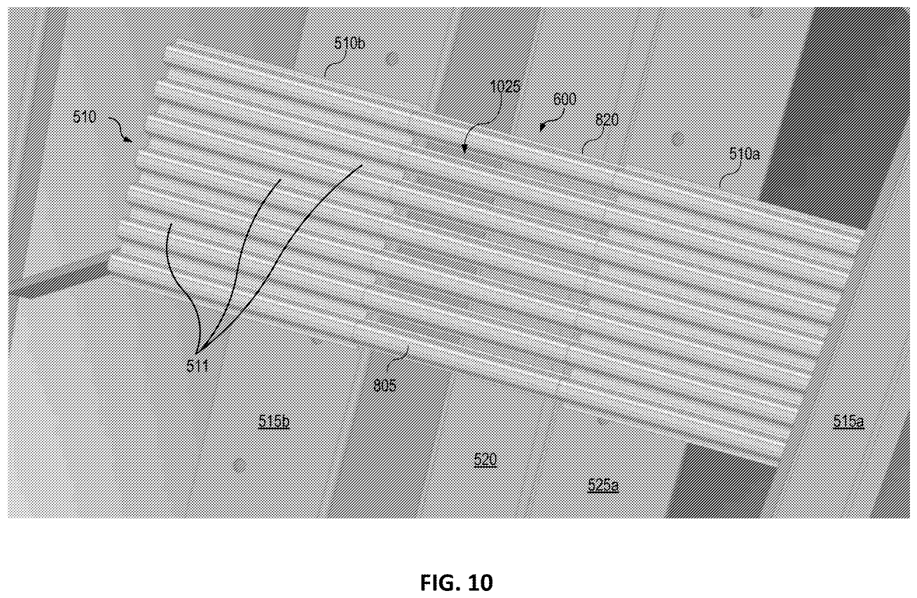

FIG. 10 is a perspective view illustrating an example of a portion of a cell vessel grid bridge assembly 600 installed in a cell vessel according to some aspects of the present disclosure. As shown in FIG. 10, when the individual cell vessel grid bridges 805 are assembled to the first and second grid portions 510a, 510b of the filtration grid 510 to form a cell vessel grid bridge assembly 600, slots or openings 1025 are formed between the center channel portions 820 of the cell vessel grid bridges 805. In some implementations, the slots or openings 1025 may have a length substantially corresponding to the length of the center channel portion 820. In some implementations, the slots or openings 1025 may have a length less than the length of the center channel portion 820. The cell vessel grid bridge assembly 600 may be positioned over the fluid collection trough 520. The cell vessel grid bridge assembly 600 can enable filtrate to be drawn through the channels 511 through the openings 1025 and into the fluid collection trough 520 under vacuum supplied to the fluid collection trough 520. The large openings can reduce clogging due to scale buildup.

The first and second end portions 610a, 610b of the cell vessel grid bridge assembly 600 may be sealed to the support plates 525a, 525b and to the first and second grid portions 510a, 510b of the filtration grid 510, for example by welding or another method, to enable vacuum to be maintained under the filter cloth.

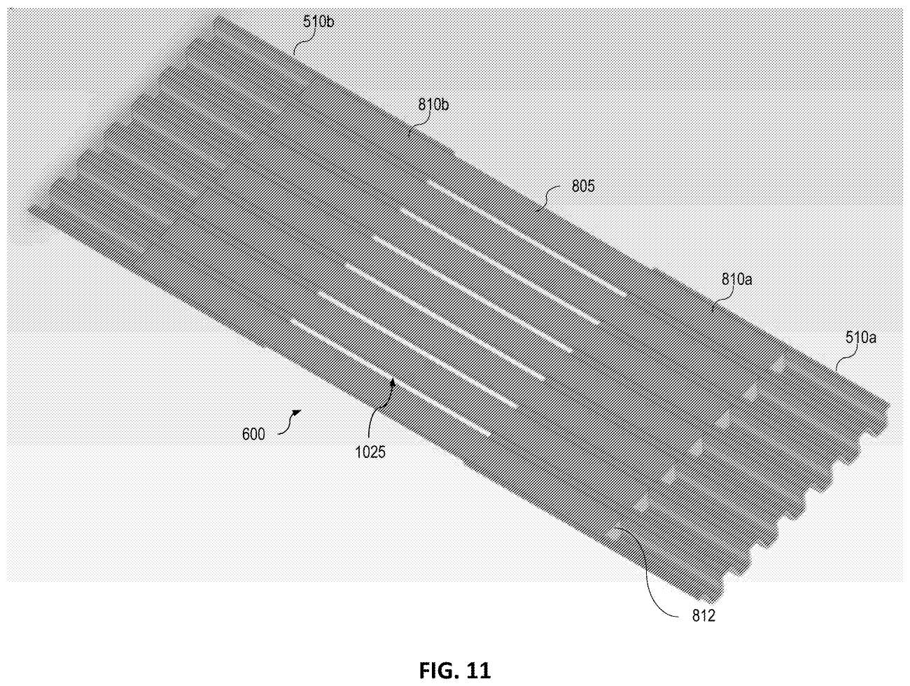

FIG. 11 is a diagram illustrating an example of bottom view of a cell vessel grid bridge assembly 600 coupled to portions of a filtration grid according to some aspects of the present disclosure. As illustrated in FIG. 11, solid cross-section 812 of the first and second end portions 810a, 810b of each cell vessel grid bridge 805 may be sealed to the first and second grid portions 510a, 510b of the filtration grid 510 to enable vacuum to be maintained under the filter cloth. FIG. 11 also illustrates the openings 1025 formed by the cell vessel grid bridge assembly 600 to permit filtrate to be drawn into the fluid collection trough 520 (see, e.g., FIG. 10).

The various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation.

The accompanying claims and their equivalents are intended to cover such forms or modifications as would fall within the scope and spirit of the protection. For example, the example apparatuses and systems disclosed herein can be applied to filters such as tilting pan filters used in the phosphoric acid, uranium, zinc, or lithium industries or other types of similar filters used in various other industries. The features and attributes of the specific example implementations disclosed above may be combined in different ways to form additional implementations, all of which fall within the scope of the present disclosure.

Although the present disclosure provides certain example implementations and applications, other implementations that are apparent to those of ordinary skill in the art, including implementations which do not provide all of the features and advantages set forth herein, are also within the scope of this disclosure. Accordingly, the scope of the present disclosure is intended to be defined only by reference to the appended claims.

1. A cell vessel, comprising:
a frame comprising a first sidewall and a second sidewall disposed opposite the first sidewall, and a first end wall and a second end wall disposed opposite the first end wall; and
a filtration grid extending from the first end wall to the second end wall, the filtration grid comprising:
a plurality of supports disposed in a parallel configuration from the first end wall to the second end wall, each support of the plurality of supports extending from the first sidewall to the second sidewall,
wherein the supports are configured to provide a first specified amount of filtration grid area as open area between adjacent supports and a second specified amount of filtration grid area as support area for a filter element of the cell vessel provided by at least a portion of an upper surface of the adjacent supports.

2. The cell vessel of claim 1, further comprising:
a fluid collection trough extending from the first end wall to the second end wall; and
support plates extending from the first end wall to the second end wall on either side of the fluid collection trough,
wherein the support plates are configured to support the filtration grid on either side of the fluid collection trough.

3. The cell vessel of claim 2, wherein the support plates comprise flat sheets.

4. The cell vessel of claim 2, wherein open areas between adjacent supports of the filtration grid comprise filtrate drainage channels.

5. The cell vessel of claim 2, wherein open areas between adjacent supports of the filtration grid disposed above the fluid collection trough comprise filtrate drainage slots configured to drain filtrate from filtrate drainage channels into the fluid collection trough.

6. The cell vessel of claim 1, wherein the supports have rectangular profiles, square profiles, or round profiles.

7. The cell vessel of claim 1, wherein the supports comprise rectangular bars or tubes.

8. The cell vessel of claim 1, wherein the supports comprise square bars or tubes, or round bars or tubes.

9. The cell vessel of claim 1, wherein the first specified amount of filtration grid area as open area comprises approximately 60% of filtration grid area, and
wherein the second specified amount of filtration grid area as support area for the filter element comprises approximately 40% of the filtration grid area.

10. The cell vessel of claim 1, wherein the first specified amount of filtration grid area as open area comprises approximately 50% of filtration grid area, and wherein the second specified amount of filtration grid area as support area for the filter element comprises approximately 50% of the filtration grid area.

11. The cell vessel of claim 1, wherein ratio of filtration grid open area with respect to filtration grid filter cloth support is in a range of 50% open area/50% filter cloth support to 60% open area/40% filter cloth support.

12. The cell vessel of claim 1, wherein the first specified amount of filtration grid area as open area comprises greater than 50% of filtration grid area, and
wherein the second specified amount of filtration grid area as support area for the filter element comprises less than 50% of the filtration grid area.

13. A filtration grid for a cell vessel, the filtration grid comprising:
a plurality of supports disposed in a parallel configuration from a first end wall to a second end wall of the cell vessel, each support of the plurality of supports extending from a first sidewall to a second sidewall of the cell vessel,
wherein the supports are configured to provide a first specified amount of filtration grid area as open area between adjacent supports and a second specified amount of filtration grid area as support area for a filter element of the cell vessel provided by at least a portion of an upper surface of the adjacent supports.

14. The filtration grid of claim 13, wherein open areas between adjacent supports of the filtration grid comprise filtrate drainage channels.

15. The filtration grid of claim 13, wherein open areas between adjacent supports of the filtration grid disposed above a fluid collection trough of the cell vessel comprise filtrate drainage slots configured to drain filtrate from filtrate drainage channels into the fluid collection trough.

16. The filtration grid of claim 13, wherein the supports have rectangular profiles, square profiles, or round profiles.

17. The filtration grid of claim 13, wherein the supports comprise rectangular bars or tubes.

18. The filtration grid of claim 13, wherein the supports comprise square bars or tubes, or round bars or tubes.

19-20. (canceled)

21. The filtration grid of claim 13, wherein ratio of filtration grid open area with respect to filtration grid filter cloth support is in a range of 50% open area 50% filter cloth support to 60% open area/40% filter cloth support.

22. The filtration grid of claim 13, wherein the first specified amount of filtration grid area as open area comprises greater than 50% of filtration grid area, and
wherein the second specified amount of filtration grid area as support area for the filter element comprises less than 50% of the filtration grid area.
